(19) United States
(12) Patent Application Publication
(10) Pub. No.: US 2010/0278153 A1
(43) Pub. Date: Nov. 4, 2010

(54) WIRELESS COMMUNICATION APPPARATUS, WIRELESS COMMUNICATION METHOD AND WIRELESS COMMUNICATION SYSTEM

(75) Inventors: Ayako Horiuchi, Kanagawa (JP); Seigo Nakao, Kanagawa (JP); Katsuhiko Hiramatsu, Kanagawa (JP); Yoshiko Saito, Kanagawa (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/812,110

(22) PCT Filed: Jan. 15, 2009
(86) PCT No.: PCT/JP2009/000134

§ 371 Date: Jul. 8, 2010

(30) Foreign Application Priority Data
Jan. 17, 2008 (JP) P2008-007970

(51) Int. Cl. H04B 7/216; G06F 11/07

(52) U.S. Cl. 370/335; 714/799; 714/E11.024

(57) ABSTRACT

The error rate characteristic in a wireless communication apparatus for relaying communications between a mobile station and a base station is improved. For the modulation level of the resource for network coding, the modulation level from a relay station to the mobile station or the modulation level from the relay station to the base station, whichever is lower, is selected and thus the modulation level becomes QPSK. The relay station preferentially assigns S1 of a systematic bit of high importance, of S1+P1 to the network coding resource. The signal of S1+P1 not assigned to the network coding resource is assigned to the resource for the base station from the relay station. In the example, S1 is assigned to the resource for network coding and P1 is assigned to the resource for the base station from the relay station.

### TECHNICAL FIELD

This invention relates to a wireless communication apparatus, a wireless communication method, and a wireless communication system for relaying communications between a first wireless communication apparatus and a second wireless communication apparatus using a network coding resource and a no-network-coding resource.

### BACKGROUND ART

In recent years, in a cellar mobile communication system, with multimedia of information, it has been a general practice to transmit not only sound data, but also large-capacity data of still image data, moving image data, etc. To realize transmission of large-capacity data, an art of realizing a high transmission rate using a high-frequency wireless band is actively examined.

However, to use a high-frequency wireless band, a high transmission rate can be expected at a short distance; on the other hand, attenuation according to the transmission distance becomes large as the distance becomes long. Therefore, to actually operate a mobile communication system using a high-frequency wireless band, the cover area of a wireless communication base station apparatus (simply, base station) becomes small and thus it becomes necessary to install a larger number of base stations. To install a base station, a considerable cost is required. Thus, there is a strong demand for an art to realize communication service using a high-frequency wireless band while suppressing an increase in the number of base stations.

For such a demand, to enlarge the cover area of each base station, a relay transmission art of installing a wireless communication relay station apparatus (simply, relay station) between a base station and a wireless communication mobile station apparatus (simply, mobile station) and conducting communications between the base station and the mobile station through the relay station is examined. To use the relay art, even a terminal that cannot directly communicate with the base station can conduct communications through the relay station.

However, in the relay art, it becomes necessary for the relay station to ensure a resource for relay and thus the effective use of the resource becomes a problem. As a method to solve the problem, applying of network coding to the relay station is examined. To begin with, the network coding will be discussed with FIG. 1.

A communication system shown in FIG. 1 is made up of a mobile station, a relay station, and a base station. The mobile station transmits a signal to the base station via the relay station and the base station transmits a signal to the mobile station via the relay station. The mobile station transmits a signal S1 to the relay station. Here, S1 is a bit string of 1111 by way of example. The base station transmits a signal S2 to the relay station. Here, S2 is a bit string of 1010 by way of example.

The relay station calculates XOR (exclusive OR) for each bit of S1 and S2 and transmits 0101 of the operation result of 1111 XOR 1010 to the mobile station and the base station. At this time, the resource used for transmission by the relay station is a resource that can be received by the mobile station and the base station. The mobile station XORs received 0101 and S1 (1111) transmitted to the relay station by the mobile station and receives 1010 of the operation result of 0101 XOR 1111. Likewise, the base station XORs received 0101 and S2 (1010) transmitted to the relay station by the base station and receives 1111 of the operation result of 0101 XOR 1010.

Thus, if network coding of performing XOR operation is applied to relay, S1 and S2 can be transmitted at the same time in the same resource, so that the effective use of the resource can be made as compared with the case where S1 and S2 are transmitted separately.

A countermeasure for the case where it becomes impossible to perform network coding if reception of a signal scheduled for network coding is erroneous is proposed (Patent Document 1).

In Patent Document 1, a resource of transmitting a network coding signal and a resource of transmitting a no-network-coding signal are provided. When network coding is performed, MCS (Modulation and Coding Scheme) is selected conforming to the lower line quality of transmission from the relay station to the base station and transmission from the relay station to the mobile station and when a no-network-coding signal is transmitted, MCS is selected conforming to the unique line quality from the relay station to the base station or from the relay station to the mobile station.

Patent Document 1: US 2007/0081603A

### DISCLOSURE OF THE INVENTION

### Problems to be Solved by the Invention

However, in Patent Document 1, from the same relay station to the base station (or from the relay station to the mobile station), a difference occurs in the reception quality because of the modulation level difference between a network coding resource and a no-network-coding resource; this is a problem.

In view of the circumstances described above, it is an object of the invention to provide a wireless communication apparatus, a wireless communication method, and a wireless communication system that can improve the error rate characteristic in a wireless communication apparatus for relaying communications between a first wireless communication apparatus and a second wireless communication apparatus.

### Means for Solving the Problems

The invention provides a wireless communication apparatus for relaying communications between a first wireless communication apparatus (for example, a mobile station) and a second wireless communication apparatus (for example, a base station) using a network coding resource and a no-network-coding resource, the wireless communication apparatus including a resource assignment section for assigning a predetermined relay signal to the network coding resource and a different relay signal other than the predetermined relay signal to the no-network-coding resource.

According to the configuration described above, the modulation level of the network coding resource (the resource for network coding) is determined conforming to the lower line quality between the line from the relay station to the base station and the line from the relay station to the mobile station. If a signal of high line quality is matched with low modulation level, the reception quality becomes excessively high and thus an important bit is assigned as a predetermined relay signal and the error rate characteristic can be improved.

In the wireless communication apparatus of the invention, the resource assignment section assigns the predetermined relay signal to the network coding resource and the different relay signal to the no-network-coding resource only when a modulation level of the network coding resource is lower than that of the no-network-coding resource.

According to the configuration described above, resource assignment of the invention can be executed only when it is reliably known that there is a difference in the line quality.

The wireless communication apparatus of the invention includes an error detection section for detecting whether or not a received signal has an error and outputting an error determination result to the resource assignment section, wherein if the error detection section detects a signal error, the resource assignment section preferentially assigns a relay signal to the network coding resource.

According to the configuration described above, the modulation level of the network coding resource is determined considering both the line quality of the line from the relay station to the mobile station and the line from the relay station to the base station and thus the probability that it may be set to low modulation level is high and thus relay signal is assigned to the resource for network coding and the error rate characteristic can be improved.

In the wireless communication apparatus of the invention, the resource assignment section has a modulation level comparison section for comparing the modulation level of the network coding resource with the modulation level of the no-network-coding resource, and if the modulation level of the network coding resource is equal to or greater than the modulation level of the no-network-coding resource, the predetermined relay signal is assigned to the no-network-coding resource.

According to the configuration described above, the SNR (Signal to Noise Ratio) of the resource for base station from the relay station or the resource for the mobile station from the relay station (no-network-coding resource) is high as compared with the SNR of the resource for network coding and thus relay signal of high importance is assigned to the no-network-coding resource and the error rate characteristic can be improved.

In the wireless communication apparatus of the invention, the resource assignment section has a modulation level change section for changing the modulation level of the network coding resource to the modulation level of the no-network-coding resource if reception of a signal scheduled for relay results in a failure and the signal cannot be relayed.

According to the configuration described above, if the modulation level of the resource for network coding is set high or low because of the effect of a different line for performing network coding, when network coding cannot be performed, the modulation level is again set considering only one line and the number of relay bits is increased, whereby the error rate characteristic can be improved.

In the wireless communication apparatus of the invention, the resource assignment section assigns the predetermined relay signal to the network coding resource or the no-network-coding resource in response to the modulation levels set in the network coding resource and the no-network-coding resource and a state of an error of the received signal.

According to the configuration described above, if reception of a signal scheduled for network coding is erroneous, the modulation level is again set considering only one line and the number of relay bits is increased, whereby the error rate characteristic can be improved.

A wireless communication method of the invention is a wireless communication method for relaying communications between a first wireless communication apparatus and a second wireless communication apparatus using a network coding resource and a no-network-coding resource, and has the step of assigning a predetermined relay signal to the network coding resource and a different relay signal other than the predetermined relay signal to the no-network-coding resource.

The wireless communication method of the invention has the step of assigning the predetermined relay signal to the network coding resource and the different relay signal to the no-network-coding resource only when a modulation level of the network coding resource is lower than that of the no-network-coding resource.

The wireless communication method of the invention has the steps of detecting whether or not a received signal is erroneous and preferentially using the network coding resource for relay if an error is detected in the received signal.

The wireless communication method of the invention has the steps of making a comparison between the modulation level of the network coding resource and the modulation level of the no-network-coding resource and assigning the predetermined relay signal to the no-network-coding resource if the modulation level of the network coding resource is equal to or greater than the modulation level of the no-network-coding resource.

The wireless communication method of the invention has the step of changing the modulation level of the network coding resource to the modulation level of the no-network-coding resource if reception of a signal scheduled for relay results in a failure and the signal cannot be relayed.

The wireless communication method of the invention has the step of assigning the predetermined relay signal to the network coding resource or the no-network-coding resource in response to the modulation level set in the network coding resource or the no-network-coding resource and the state of an error of the received signal.

A wireless communication system of the invention is a wireless communication system including a relay station for relaying communications between a first wireless communication apparatus and a second wireless communication apparatus using a network coding resource and a no-network-coding resource, wherein the relay station includes a resource assignment section for assigning a predetermined relay signal to the network coding resource and a different relay signal other than the predetermined relay signal to the no-network-coding resource.

### ADVANTAGES OF THE INVENTION

According to the wireless communication apparatus, the wireless communication method, and the wireless communication system according to the invention, the modulation level of the network coding resource is determined conforming to the lower line quality between the line from the home apparatus to the first wireless communication apparatus and the line from the home apparatus to the second wireless communication apparatus. If a signal of high line quality is matched with low modulation level, the reception quality becomes excessively high and thus an important bit is assigned to the network coding resource as a predetermined relay signal and the error rate characteristic can be improved.

### BRIEF DESCRIPTION OF THE DRAWINGS

FIG. 1 is a drawing to describe network coding.

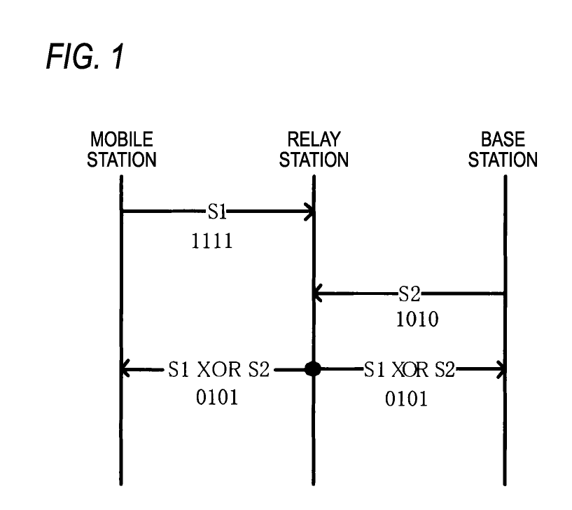

FIG. 2 is a drawing to describe the operation of a relay station for relaying communications between a mobile station and a base station.

FIG. 3 is a drawing to describe an operation example of a wireless communication method according to Embodiment 1 of the invention.

FIG. 4 is a block diagram to describe the schematic configuration of a relay station apparatus according to Embodiment 1 of the invention.

FIG. 5 is a block diagram to describe the schematic configuration of a resource assignment section according to Embodiment 1 of the invention.

FIG. 6 is a block diagram to describe the schematic configuration of a mobile station apparatus according to Embodiment 1 of the invention.

FIG. 7 is a drawing to describe an operation example of a wireless communication method according to Embodiment 2 of the invention.

FIG. 8 is a block diagram to describe the schematic configuration of a relay station apparatus according to Embodiment 2 of the invention.

FIG. 9 is a block diagram to describe the schematic configuration of a resource assignment section according to Embodiment 2 of the invention.

FIG. 10 is a block diagram to describe the schematic configuration of a relay station apparatus according to Embodiment 2 of the invention.

FIG. 11 is a drawing to describe an operation example of a wireless communication method according to Embodiment 3 of the invention.

FIG. 12 is a block diagram to describe the schematic configuration of a resource assignment section according to Embodiment 3 of the invention.

FIG. 13 is a flowchart to describe resource switching according to Embodiment 3 of the invention.

FIG. 14 is a drawing to describe an operation example of a wireless communication method according to Embodiment 4 of the invention.

FIG. 15 is a block diagram to describe the schematic configuration of a relay station apparatus according to Embodiment 4 of the invention.

FIG. 16 is a block diagram to describe the schematic configuration of a resource assignment section according to Embodiment 4 of the invention.

FIG. 17 is a flowchart to describe resource switching according to Embodiment 3 of the invention.

### DESCRIPTION OF REFERENCE NUMERALS

1 Mobile station
2 Relay station
3 Base station
11, 12, 41 Error correction coding section
13, 58, 124 Resource assignment section
14, 19, 125 XOR section
15, 16, 17, 42 Modulation section
18, 19, 20, 43 Wireless transmission section
21, 22, 23, 31, 32, 44, 52 Antenna
24, 25 48 Error correction decoding section
26, 27, 50 LLR section
28, 29 Signal separation section
30, 31, 51 Wireless reception section
35, 82, 111, 152 Importance determination section
36, 83, 113, 155 Signal assignment amount calculation section
37, 84, 114, 153 Data separation section
45, 95 Bit conversion section
46, 96 Bit selection section
47, 97 Buffer
49 Bit computation section
57, 123 Error detection section
60, 126 ACK/NACK generation section
81, 151 Signal removal section
98 ACK/NACK reception section
112, 154 Modulation level comparison section
156 Modulation level change section

### BEST MODE FOR CARRYING OUT THE INVENTION

Embodiments of the invention will be discussed below with reference to the accompanying drawings:

### Embodiment 1

To relay communications between a mobile station (first wireless communication apparatus) and a base station (second wireless communication apparatus), when relaying communications using both a network coding resource (resource for network coding) and a no-network-coding resource (resource for the base station from relay station or resource for the mobile station from relay station), a wireless communication apparatus of Embodiment 1 of the invention assigns a bit of high importance to the network coding resource.

For the network coding resource, the modulation level is determined conforming to the low line quality of the line quality from the relay station to the base station and that from the relay station to the mobile station and thus the possibility that the modulation level may be low is high as compared with the no-network-coding resource. If the modulation level is low, the reception quality becomes high and thus an important bit is assigned to the network coding resource of high reception quality, whereby the error rate characteristic can be improved.

[Operation Drawing]

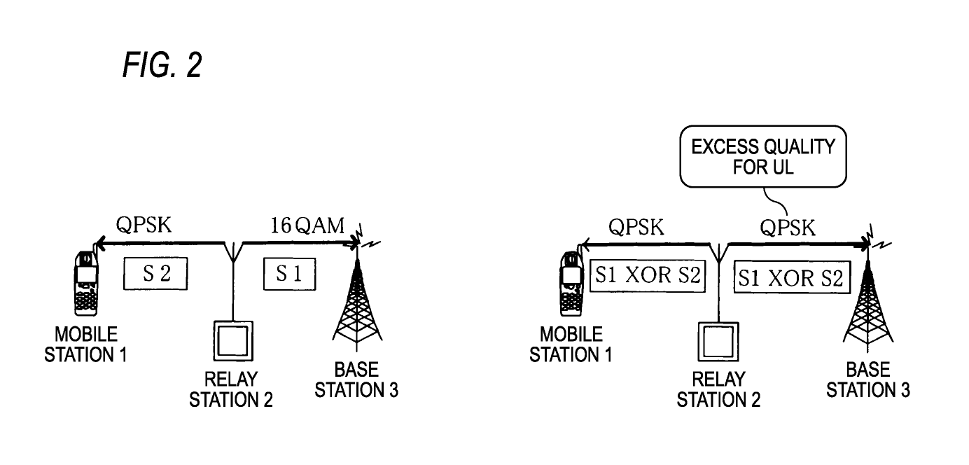

Before the description of the embodiment, first a related art system will be discussed. Assume that the modulation level fitted to the line quality from a relay station to a base station is 16QAM and the modulation level fitted to the line quality from the relay station to a mobile station is QPSK. The left drawing of FIG. 2 shows an example of no network coding. For no network coding, a signal S1 is 16QAM-modulated and is relayed from a relay station 2 to a base station 3 and a signal S2 is QPSK-modulated and is relayed from the relay station 2 to a mobile station 1. Thus, for no network coding, the modulation level fitted to the home line can be determined without receiving the effect from any other line.

The right drawing of FIG. 2 shows an example of network coding. For network coding, a signal is transmitted from the relay station 2 to the mobile station 1 and the base station 3 at the same time and thus the modulation levels of both lines must be made uniform. In the drawing, relay is executed in QPSK modulation from the relay station 2 to the mobile station 1 and the base station 3 conforming to transmission from the relay station 2 to the mobile station 1 with low line quality. In so doing, relay is executed in QPSK modulation regardless of the line quality capable of transmitting in 16QAM from the relay station 2 to the base station 3 and thus excess quality occurs.

Therefore, a difference occurs in the reception quality from the relay station 2 to the base station 3 between existence of network coding and no existence of network coding. In the example, when network coding exists, the modulation level is determined based on the lower line quality of transmission from the relay station 2 to the base station 3 and that from the relay station 2 to the mobile station 1. Thus, a reception quality difference from no existence of network coding occurs in the line whose line quality is high. This point is effectively used in the embodiment.

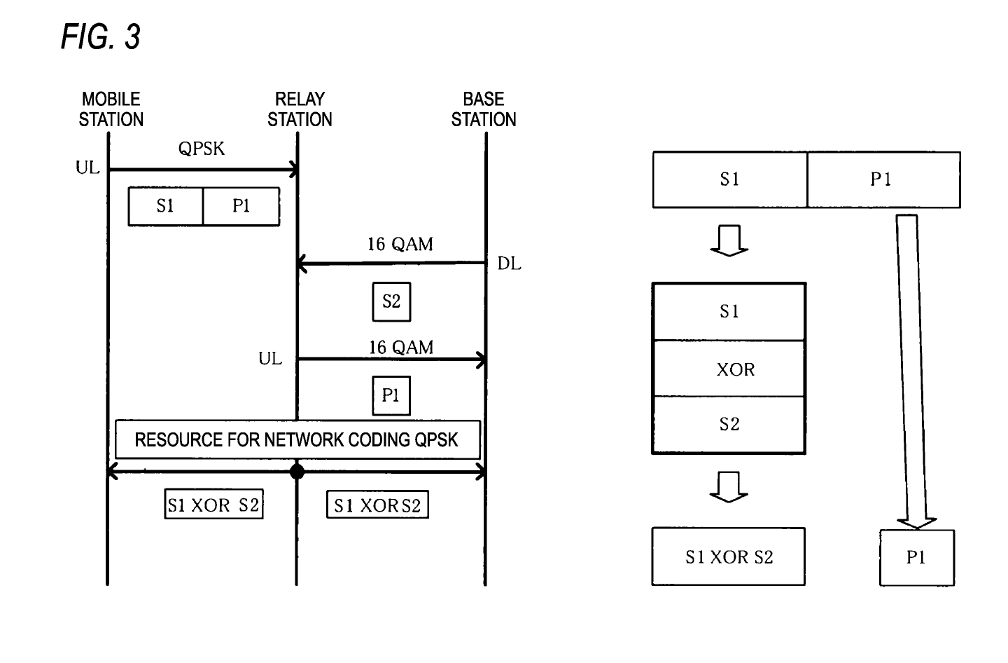

FIG. 3 shows an operation example of the embodiment. Assume that the modulation level from the mobile station to the relay station and from the relay station to the mobile station is QPSK and the modulation level from the base station to the relay station and from the relay station to the base station is 16QAM. First, signal S1+P1 is transmitted in QPSK from the mobile station to the relay station. S1 is a systematic bit and P1 is a parity bit.

Next, S2 is transmitted from the base station to the relay station. The signal S1+P1 relayed to the base station and the signal S2 relayed to the mobile station differ in the number of bits; the number of bits of S1+P1 is larger than that of S2. Of resource for relay, the resource amount of the resource for network coding is determined based on S2 and of S1+P1, the signal that cannot be transmitted to the resource for network coding is relayed using the resource for the base station from the relay station.

For the modulation level of the resource for network coding, the modulation level from the relay station to the mobile station or the modulation level from the relay station to the base station, whichever is lower, is selected and thus the modulation level becomes QPSK. Since the modulation level from the relay station to the base station is 16QAM, the reception quality of the signal relayed using the resource for network coding in QPSK modulation becomes higher than that of the signal transmitted with the resource for the base station from the relay station in 16QAM.

Then, the relay station of the embodiment preferentially assigns S1 of the systematic bit of high importance, of S1+P1 to the resource for network coding. The signal of S1+P1 not assigned to the resource for network coding is assigned to the resource for the base station from the relay station. In the example, S1 is assigned to the resource for network coding and P1 is assigned to the resource for the base station from the relay station.

In so doing, the signal S1 of high importance is relayed in QPSK with the low modulation level and the signal P1 of low importance is relayed in 16QAM with the high modulation level, so that the error rate characteristic of the bit of high importance can be improved.

[Relay Station Block Diagram]

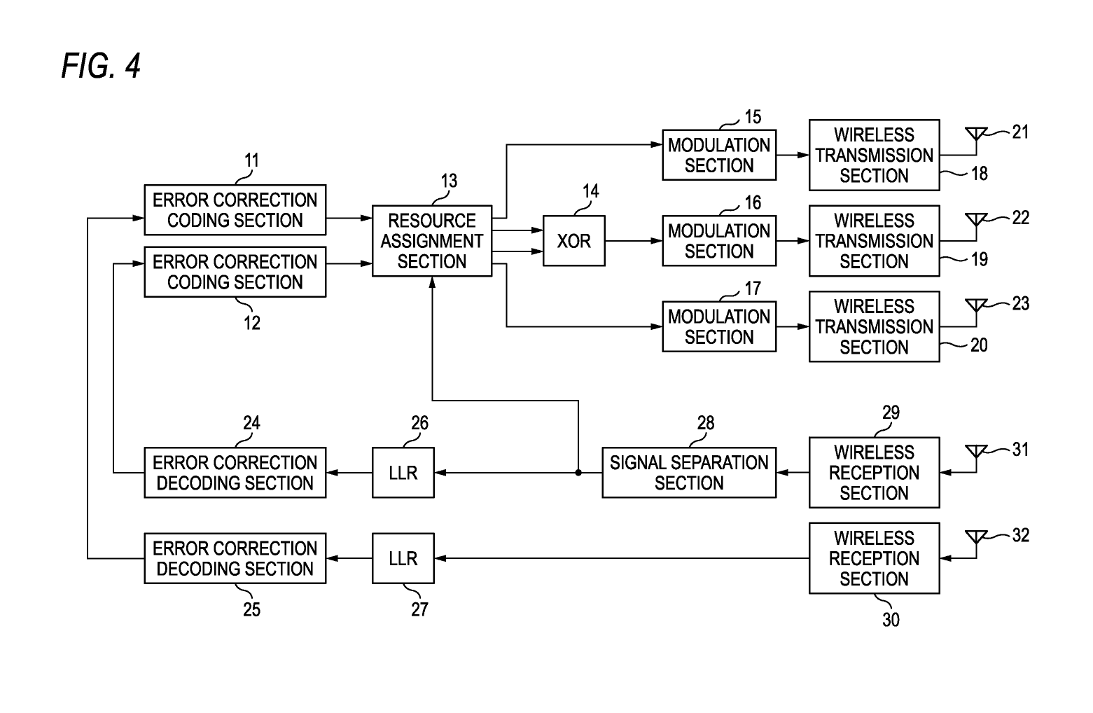

FIG. 4 is a block diagram to show the configuration of the relay station according to the embodiment. A wireless reception section 29 receives a signal from the mobile station through an antenna 31 and a wireless reception section 30 receives a signal from the mobile station through an antenna 32 and each performs wireless processing of down convert, etc. The wireless reception section 29 outputs the signal subjected to the wireless processing to a signal separation section 28. The wireless reception section 30 outputs the signal subjected to the wireless processing to LLR 27.

The signal separation section 28 outputs resource assignment information (for example, resource number, modulation level, coding rate, etc.,) received from the base station, of the signal output from the wireless reception section 29 to a resource assignment section 13 and outputs a relay signal from the base station to the mobile station to an LLR 26 section.

The LLR sections 26 and 27 calculate log likelihood ratio (LLR) of a soft determination value of a signal from the mobile station and a signal from the base station and output the LLR to error correction decoding sections 24 and 25 respectively. The error correction decoding sections 24 and 25 use the LLR to perform error correction decoding of the signal from the mobile station and the signal from the base station, and output the result to error correction coding sections 11 and 12 respectively.

The error correction coding sections 11 and 12 again perform error correction coding of the signals whose errors are corrected by the error correction decoding sections 24 and 25 and input the signals to the resource assignment section 13. The resource assignment section 13 assigns the relay signal from the mobile station to the base station and the relay signal from the base station to the mobile station to the resource for network coding, the resource for the mobile station from the relay station, and the resource for the base station from the relay station using the resource assignment information received from the base station.

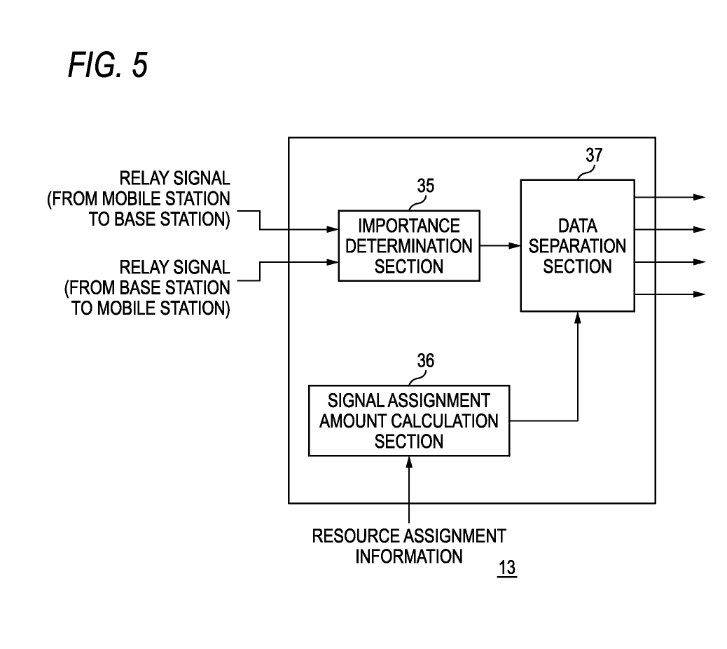

The operation of the resource assignment section 13 will be discussed with reference to FIG. 5. The resource assignment section 13 has an importance determination section 35, a signal assignment amount calculation section 36, and a data separation section 37. Relay signals (a relay signal from the mobile station to the base station and a relay signal from the base station to the mobile station) are input to the importance determination section 35 of the resource assignment section 13. The importance determination section 35 determines importance of each relay signal based on the preset reference and inputs a signal of high importance and a signal of not high importance discriminately to the data separation section 37. In the example shown in FIG. 3, the importance determination section 35 discriminates between the signal S1 of high importance and the signal P1 of not high importance and inputs them to the data separation section 37. Resource assignment information received from the base station is input to the signal assignment amount calculation section 36.

The resource assignment information contains the resource amount for network coding, the resource amount for the base station from the relay station, the resource amount for mobile station from the relay station, and information of MCS (Modulation and Coding Scheme) each resource. The signal assignment amount calculation section 36 calculates the signal amount that can be transmitted to each resource from the resource assignment information. The calculation result is input to the data separation section 37.

For the input signals subjected to the importance determination, the data separation section 37 first assigns a signal of high importance to the resource for network coding based on the signal amount that can be transmitted to each resource and outputs the signal to the XOR section 14. On the other hand, the data separation section 37 assigns the signal not assigned to the resource for network coding to the resource for the base station from the relay station or the resource for the mobile station from the relay station and outputs the signal to modulation sections 15 and 17.

The XOR section 14 shown in FIG. 4 XORs the signal of high importance assigned to the resource for network coding and outputs the result to the modulation section 16. The modulation sections 15, 16, and 17 again convert the signal from the mobile station and the signal from the base station and output the signals to wireless transmission sections 18, 19, and 20. The wireless transmission sections 18, 19, and 20 perform wireless processing of up convert, etc., for the post-modulated signals and relay and transmit the signals from antennas 21, 22, and 23 to the base station and the mobile station.

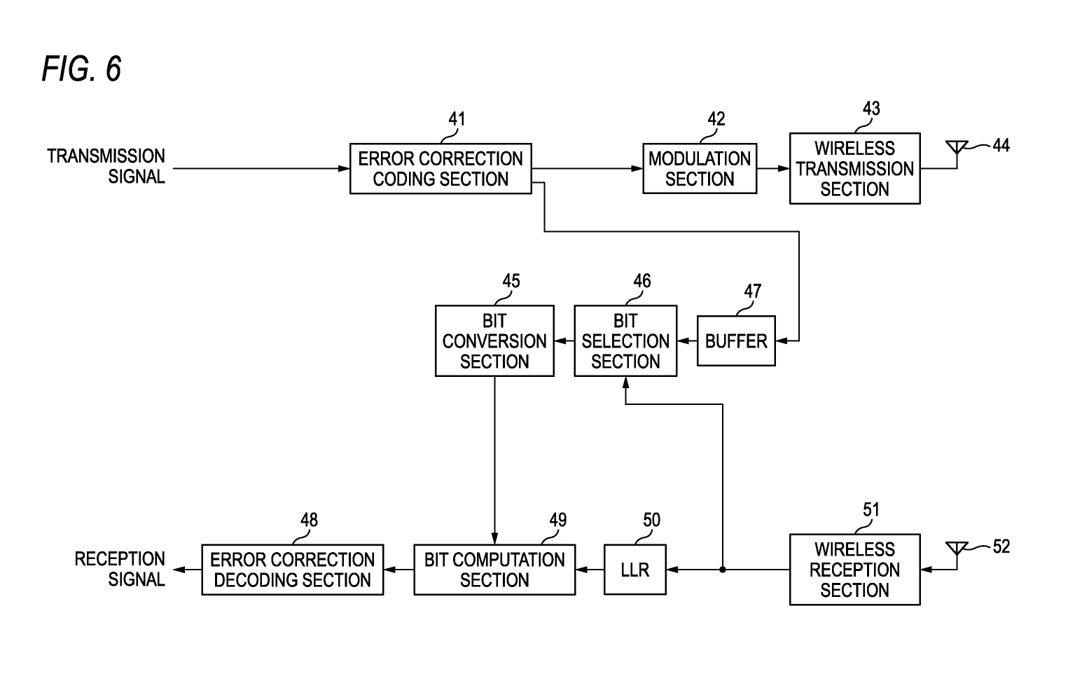

FIG. 6 is a block diagram to show the configuration of a mobile station apparatus according to the embodiment of the invention. Portions identical with those of the block diagram of the relay station in FIG. 4 will not be discussed again. A buffer section 47 saves the signal subjected to error correction coding in an error correction coding section 41 and the signal to a bit selection section 46.

The bit selection section 46 calculates how many bits of a signal are transmitted in the resource for network coding from the reception resource amount for network coding and the modulation level and selects as many bits as the number of bits subjected to network coding in the importance order (from high to low) and outputs the bits to a bit conversion section 45.

The bit conversion section 45 converts the signal output from the buffer 47 into −1 if the signal is 1 and into 1 if the signal is 0 to generate a bit string, and outputs the bit string to a bit computation section 49. The bit computation section 49 multiplies the signal output from the LLR section 50 by the signal output from the bit conversion section 45. The multiplication result signal is output to an error correction decoding section 48.

Thus, according to the embodiment, to use together the resource for network coding and the resource for base station from the relay station or the resource for mobile station from the relay station, a bit of high importance is transmitted to the resource for network coding, whereby the error rate characteristic can be improved

The example wherein the signals from the relay station to the base station is many as compared with the signals from the relay station to the mobile station is show; in contrast, the embodiment may be applied to the case where the signals from the relay station to the mobile station is many. The embodiment may be applied only when the MCS level assigned to the resource for network coding is lower than the MCS level assigned to the resource from the relay station to the base station. The level which is low means that the modulation level is low or the coding rate is low. The lower the MCS level, the higher the error rate characteristic on the reception side.

### Embodiment 2

In a wireless communication apparatus of Embodiment 2, if a relay station partially fails to receive a signal scheduled for relay and cannot relay, the resource for network coding is preferentially used for relay. For the resource for network coding, the modulation level is determined considering both the line quality from the relay station to a mobile station and the line quality from the relay station to a base station and thus the probability that it may be set to low modulation level is high. Therefore, the resource for network coding is preferentially used, whereby the error rate characteristic can be improved.

[Operation Drawing]

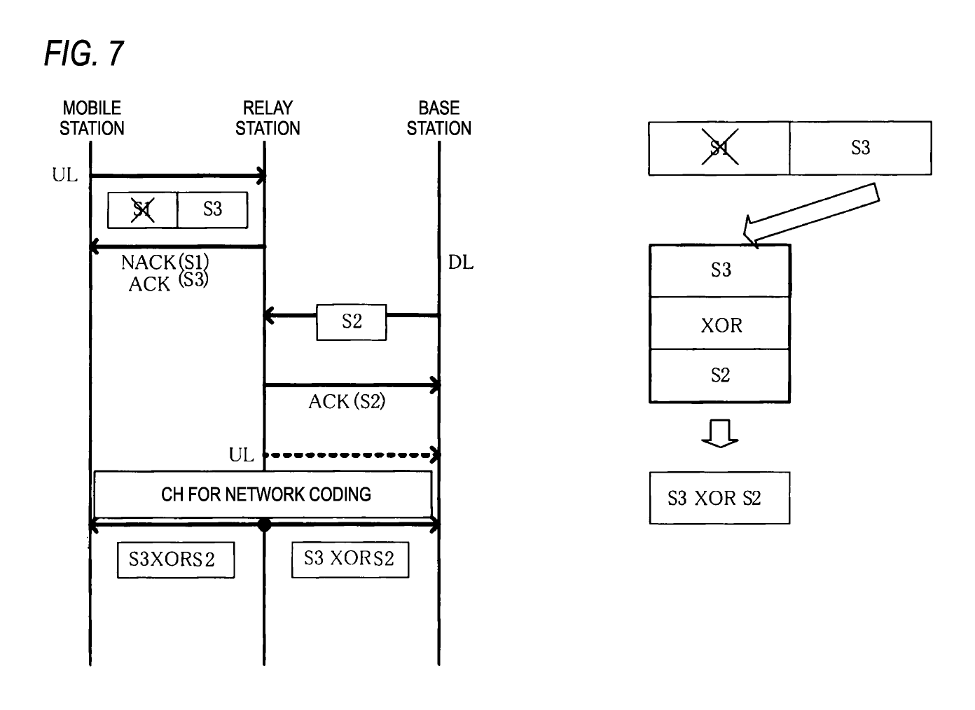

FIG. 7 shows an operation example of the embodiment. Like Embodiment 1, it is assumed that the modulation level from the mobile station to the relay station and from the relay station to the mobile station is QPSK and the modulation level from the base station to the relay station and from the relay station to the base station is 16QAM.

The mobile station transmits a signal S1 and a signal S3 in QPSK to the relay station and the base station transmits a signal S2 in 16QAM to the relay station. Here, assume that signal S1+S3 relayed to the base station and signal S2 relayed to the mobile station differ in the number of bits and the number of bits of S1+S3 is larger than that of S2.

Of the resource for relay, the resource for network coding is assigned based on S2 and the signal of S1+S3 that cannot be transmitted to the resource for network coding is relayed using the resource for base station from the relay station.

In the example, it is assumed that S1 is more important than S3. If both S1 and S2 can be correctly received at the relay station, S1 of high importance is assigned to the resource for network coding and S3 is assigned to the resource from the relay station to the base station based on Embodiment 1. The resource for network coding is set to QPSK conforming to S2 and the resource for the base station from the relay station for transmitting S3 is set to 16QAM.

The case where when the relay station receives S1 and S3 from the mobile station, reception of S1 is erroneous and relay of S1 is stopped will be discussed. In this case, the relay station transmits NACK of S1 and ACK of S3 to the mobile station. When relay of S1 is stopped, the relay station assigns S3 to the resource for network coding.

S3 is scheduled for transmission in 16QAM, but can be transmitted in QPSK as it is transmitted in the resource for network coding. Transmission of the resource from the relay station to the base station scheduled for transmission of S3 may be stopped or a signal in the buffer of the relay station may be transmitted.

Thus, when reception of a signal scheduled for network coding is erroneous, if the signal that can be received is assigned to the resource for network coding, the error rate characteristic of the signal that can be received can be improved. When the mobile station receives NACK indicating that reception of S1 in the relay station from the relay station, the mobile station sees that S3 is subjected to network coding with S2 for transmission instead of S1 and thus can receive S2 correctly.

[Relay Station Block Diagram]

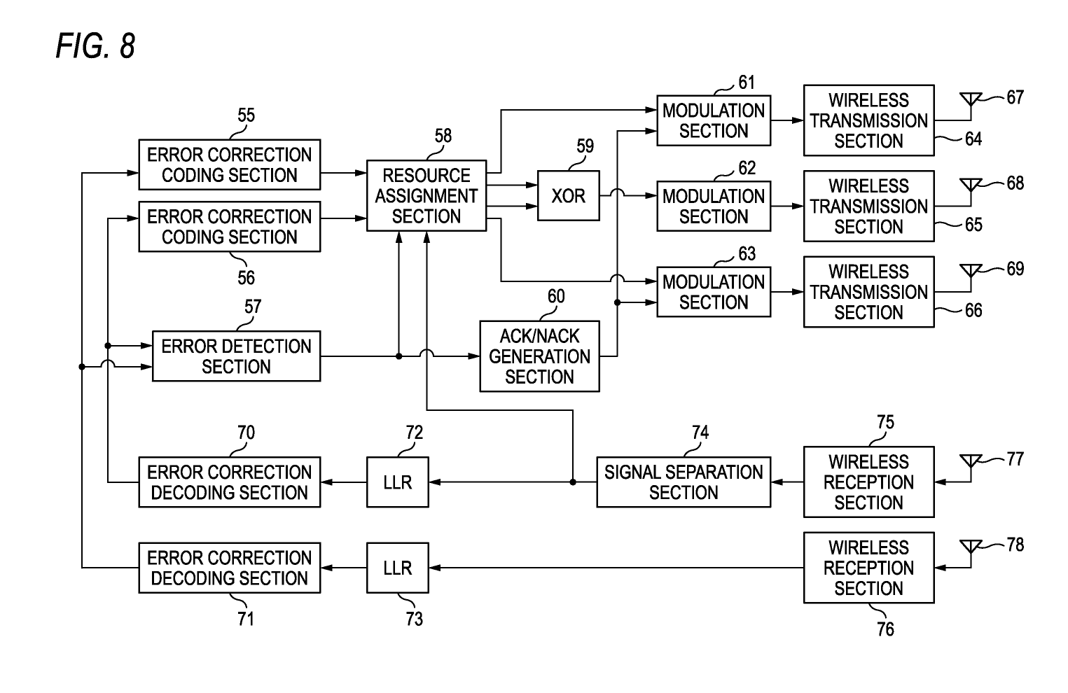

FIG. 8 is a block diagram to show the configuration of a relay station apparatus according to the embodiment. Portions similar to those in the block diagram of FIG. 4 will not be discussed again. An error detection section 57 detects whether or not the signals subjected to error correction in error correction decoding sections 70 and 71 contain an error. The error detection section 57 outputs the correction result to an ACK/NACK generation section 60 and a resource assignment section 58. From the error detection result, the ACK/NACK generation section 60 generates ACK if no error exists and generates NACK if an error exists and outputs ACK or NACK to modulation sections 61 and 63.

The resource assignment section 58 assigns the relay signal from the mobile station to the base station and the relay signal from the base station to the mobile station to the resource for network coding, the resource for the mobile station from the relay station, and the resource for the base station from the relay station using the resource assignment information received from the base station and the error determination result generated in the error detection section 57.

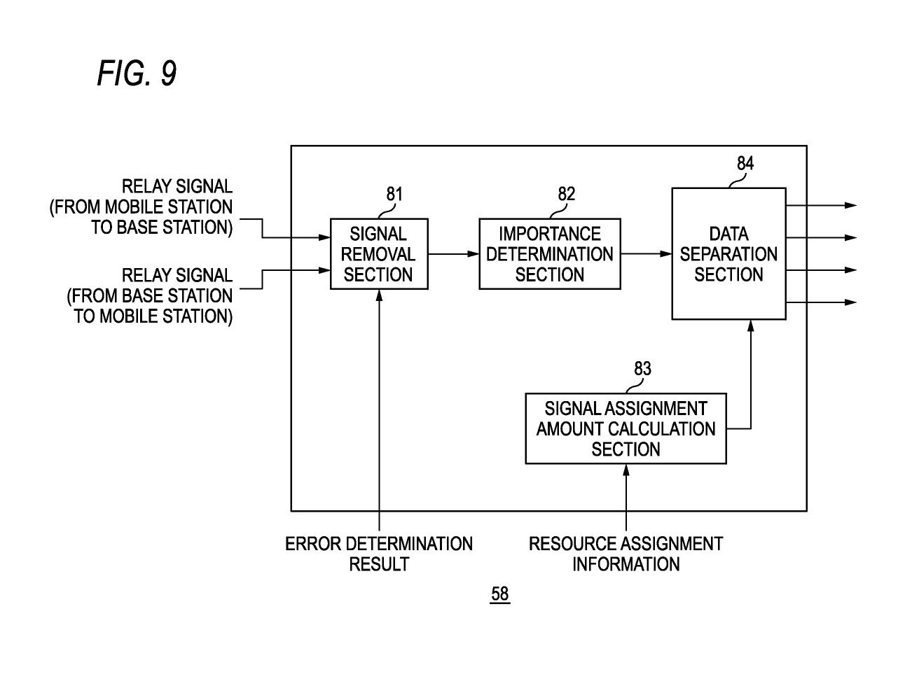

The operation of the resource assignment section 58 will be discussed with reference to FIG. 9. Portions similar to those in FIG. 5 will not be discussed again. The resource assignment section 58 shown in FIG. 9 has a signal removal section 81 in addition to the configuration shown in FIG. 5. The relay signals (relay signal from the mobile station to the base station and relay signal from the base station to the mobile station) and the error determination result output from the error detection section 57 are input to the signal removal section 81. The signal removal section 81 removes a signal with an error from the relay signals (relay signal from the mobile station to the base station and relay signal from the base station to the mobile station) and outputs only a signal with no error to an importance determination section 82 based on the error determination result.

[Mobile Station Block Diagram]

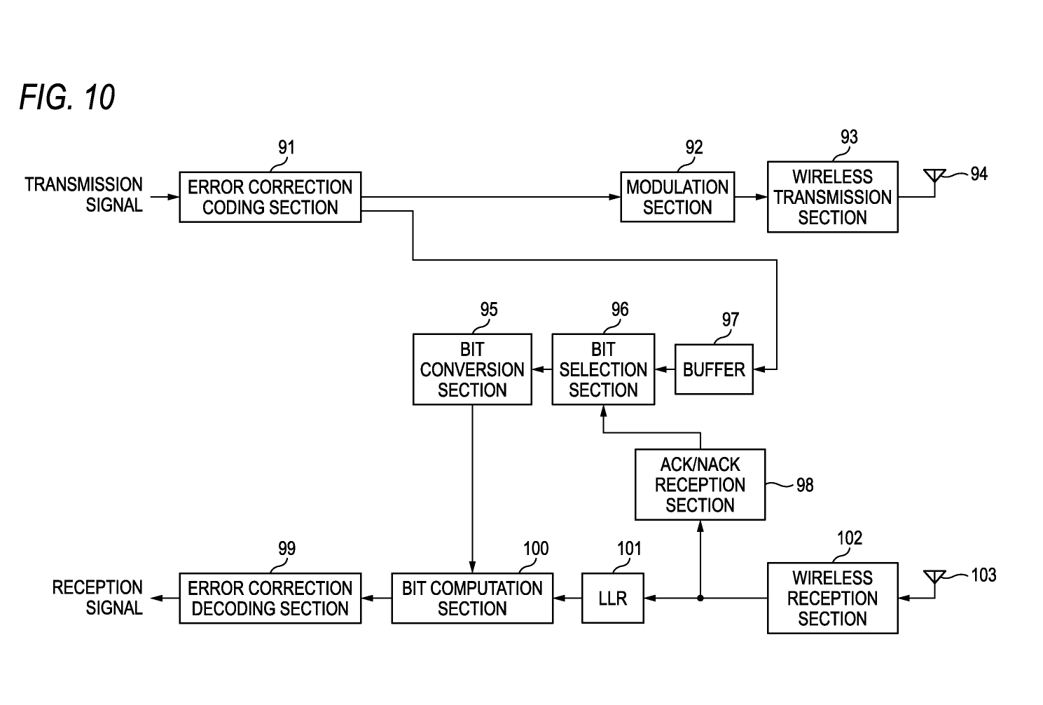

FIG. 10 is a block diagram to show the configuration of a mobile station apparatus according to the embodiment of the invention. Portions similar to those in the block diagram of FIG. 6 will not be discussed again. An ACK/NACK reception section 98 receives ACK/NACK transmitted from the relay station and outputs ACK/NACK to a bit selection section 96.

When receiving ACK of a signal of high importance, the bit selection section 96 determines that a signal of high importance is XORed in the resource for network coding, and outputs the signal of high importance to a bit conversion section 95. When receiving NACK of a signal of high importance and ACK of a signal of low importance, the bit selection section 96 determines that a signal of low importance is XORed in the resource for network coding, and outputs the signal of low importance to the bit conversion section 95. When receiving NACK of a signal of high importance and NACK of a signal of low importance, the bit selection section 96 determines that nothing is XORed in the resource for network coding, and outputs a bit string of 0 to the bit conversion section 95.

In the embodiment, if the relay station fails to receive a signal of high importance, the resource for network coding is assigned to a signal of low importance. The possibility that the resource for network coding may be set to a lower modulation level than the resource from the relay station to the base station or the resource from the relay station to the mobile station is high and thus the error rate characteristic of a signal of low importance can be improved. If S3 cannot completely be transmitted in the resource for network coding only, the resource for the base station from the relay station or the resource for the mobile station from the relay station may be used together.

### Embodiment 3

In Embodiment 3, unlike Embodiment 1 or 2, to use together the resource for network coding and the resource for the base station from the relay station or the resource for the mobile station from the relay station, an important relay signal is assigned to the resource from the relay station to the base station or the resource from the relay station to the mobile station. As the resource for network coding, the resource with good line quality of two lines from the relay station to the base station and from the relay station to the mobile station is selected. That is, the resource with particularly good line quality of one line and poor line quality of the other is not selected and the resource with the line quality of both lines better than one reference. Therefore, the resource for network coding has a feature that SNR (Signal to Noise Ratio) is low as compared with the resource for the base station from the relay station or the resource for the mobile station from the relay station. Using the feature, an important bit is preferentially assigned to the resource for the base station from the relay station or the resource for the mobile station from the relay station, whereby the error rate characteristic can be improved.

Particularly, when the resource for network coding and the resource for the base station from the relay station or the resource for the mobile station from the relay station use the same modulation level, the error rate characteristic is improved effectively. If the resource for network coding is a distributed resource, the resource for network coding becomes averaged SNR; as the resource for the base station from the relay station or the resource for the mobile station from the relay station, a resource with high SNR can be selected and thus also in this case, the embodiment is useful.

[Operation Drawing]

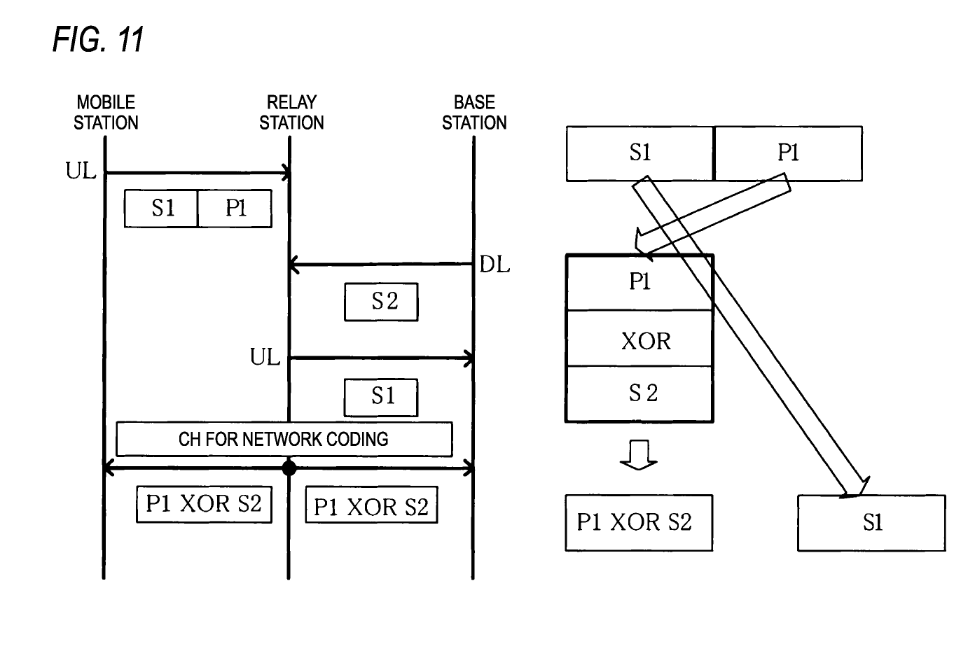

FIG. 11 is an operation drawing of the embodiment. First, signal S1+P1 is transmitted from the mobile station to the relay station. S1 is a systematic bit and P1 is a parity bit. Next, S2 is transmitted from the base station to the relay station. Here, the signal S1+P1 relayed to the base station and signal S2 relayed to the mobile station differ in the number of bits and the number of bits of S1+P1 is larger than that of S2.

Of the resource for relay, the resource amount of the resource for network coding is determined based on S2 and the signal of S1+P1 that cannot be transmitted to the resource for network coding is relayed using the resource for the base station from the relay station.

As the resource for network coding, the resource with good line quality of two lines from the relay station to the base station and from the relay station to the mobile station and thus the resource for network coding has a feature that a resource with high SNR is hard to select as compared with the resource for the base station from the relay station or the resource for the mobile station from the relay station.

When the resource for network coding is distributed and is arranged, the SNR of the resource for network coding is averaged as compared with the resource for the base station from the relay station or the resource for the mobile station from the relay station. Therefore, the resource for network coding has a feature that it becomes lower than the resource for the base station from the relay station or the resource for the mobile station from the relay station selecting the quality with high SNR.

Then, the relay station preferentially assigns S1 of the systematic bit of high importance, of S1+P1 to the resource for the base station from the relay station. In the example, S1 is assigned to the resource for the base station from the relay station and P1 is assigned to the resource for network coding.

In so doing, the signal S1 of high importance is relayed in the resource with high SNR and the signal P1 of low importance is relayed in the resource with low SNR, so that error rate characteristic of a bit of high importance can be improved.

The embodiment, particularly, unlike Embodiment 1 or 2, is effective when the resource for network coding and the resource for the base station from the relay station or the resource for the mobile station from the relay station use the same modulation level. If the modulation level is the same, the higher the SNR, the higher the error rate characteristic and the lower the SNR, the lower the error rate characteristic.

[Block Diagram]

A block diagram of the relay station and a detailed drawing of the source assignment section 13 are similar to the block diagrams of FIGS. 4 and 5 respectively. However, the operation of a data separation section 37 of the resource assignment section 13 differs. The data separation section 37 of the embodiment first assigns the input signal of high importance as the importance determination result to the resource for the base station from the relay station or the resource for the mobile station from the relay station based on the signal amount that can be transmitted to each resource and outputs to modulation sections 15 and 17. The data separation section 37 of the embodiment assigns the signal not assigned to the resource for the base station from the relay station or the resource for the mobile station from the relay station to the resource for network coding and outputs the signal to an XOR section 14.

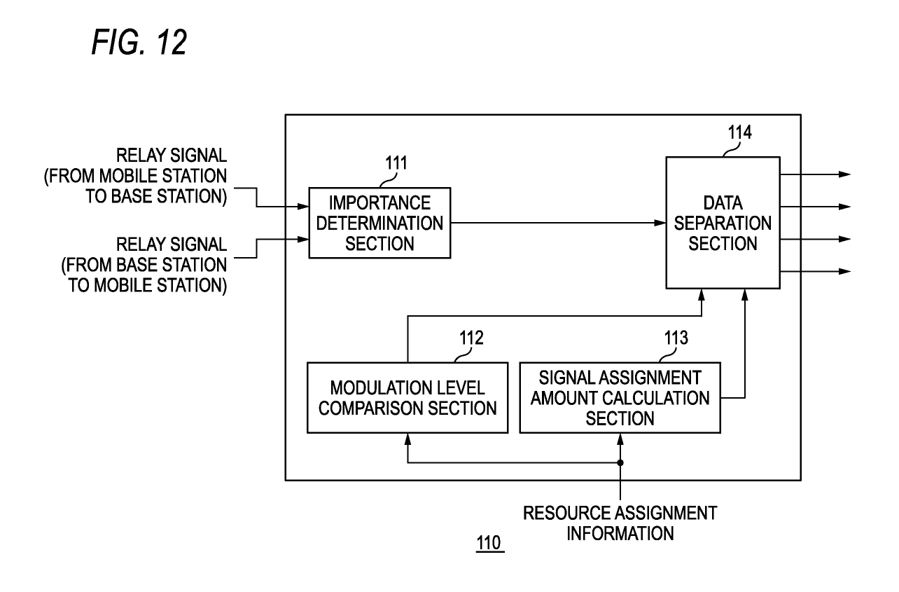

Next, FIG. 12 is a detailed drawing of a resource assignment section 110 when the operation of Embodiment 1 and the operation of Embodiment 3 is switched according to the modulation level. The resource assignment section 110 shown in FIG. 12 has a modulation level comparison section 112 in addition to the configuration of the resource assignment section 13 shown in FIG. 5. Portions similar to those in FIG. 5 will not be discussed again. Resource assignment information is output to the modulation level comparison section 112 and a signal assignment amount calculation section 113. The modulation level comparison section 112 makes a comparison between the modulation level of the resource for network coding and the modulation level of the resource for the base station from the relay station or the resource for the mobile station from the relay station, and outputs the comparison result to a data separation section 114.

The data separation section 114 performs similar operation to that of Embodiment 1 for data subjected to importance determination if the comparison result is the lower modulation level of the resource for network coding. On the other hand, if the modulation level of the resource for network coding is equal to or greater than that of the resource used together, the data separation section 114 preferentially assigns a signal of high importance to the resource for the base station from the relay station or the resource for the mobile station from the relay station and outputs to the modulation sections 15 and 17 and assigns a signal of low importance to the resource for network coding and outputs the signal to the XOR section 14.

A block diagram of the mobile station is similar to the block diagram of FIG. 6. However, the operation of a bit selection section 46 differs. The bit selection section 46 of the embodiment calculates how many bits of a signal are transmitted in the resource for the base station from the relay station from the modulation level and the resource amount assigned from the relay station to the base station and subtracts the calculated number of bits from the number of bits output from a buffer 47, thereby finding the number of bits subjected to network coding. The bit selection section 46 of the embodiment selects the bit subjected to network coding in the ascending order of the importance degree and outputs the bit to a bit conversion section 45.

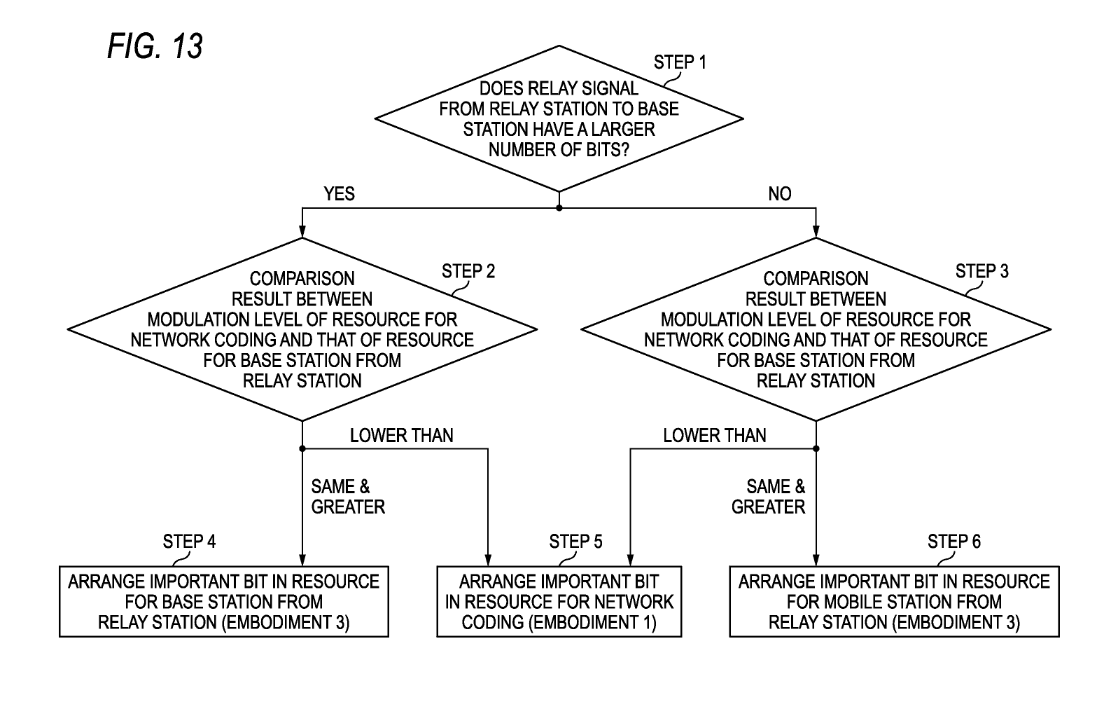

FIG. 13 shows a flow for switching in Embodiment 1 and Embodiment 3 in the resource assignment section 110 of the relay station shown in FIG. 12. If the relay signal from the relay station to the base station has a larger number of bits to be relayed than the relay signal from the relay station to the mobile station at (Step 1), the process goes to (Step 2); if the relay signal from the relay station to the mobile station has a larger number of bits than the relay signal from the relay station to the base station, the process goes to (Step 3).

If the modulation level of the resource for network coding is higher than or the same as that of the resource for the base station from the relay station, the process goes to (Step 4); otherwise, the process goes to (Step 5).

If the modulation level of the resource for network coding is higher than or the same as that of the resource for the mobile station from the relay station, the process goes to (Step 6); otherwise, the process goes to (Step 5).

At (Step 4), an important bit is arranged in the resource for the base station from the relay station as in (Embodiment 3). At (Step 5), an important bit is arranged in the resource for network coding as in (Embodiment 1). At (Step 6), an important bit is arranged in the resource for the mobile station from the relay station as in (Embodiment 3).

In switching of Embodiment 1 and Embodiment 3, in comparison between the modulation level of the resource for network coding and that of the resource for the base station from the relay station and that of the resource for the mobile station from the relay station (Step 2 and Step 3), the modulation level of the resource for network coding is equal to or greater than, Embodiment 3 is set; the modulation level of the resource for network coding is lower than, Embodiment 1 is set. However, the modulation level of the resource for network coding is the same as, Embodiment 3 may be set; when the modulation level of the resource for network coding is higher or lower than, Embodiment 1 may be set.

### Embodiment 4

In Embodiment 4, the case where a difference exists between the line quality between a relay station and a mobile station and the line quality between a relay station and a base station and the setup modulation levels differ is assumed. At this time, if a reception error occurs between the mobile station and the relay station or between the base station and the relay station, it becomes unnecessary to perform network coding. In this case, a bit of high importance is assigned to the resource for the mobile station from the relay station or the resource for the base station from the relay station.

Thus, if a signal scheduled for network coding cannot be received and a change can be made to the modulation level matched with one link for relay, the modulation level can be set to that matched with the link, so that the error rate characteristic can be improved.

[Operation Drawing]

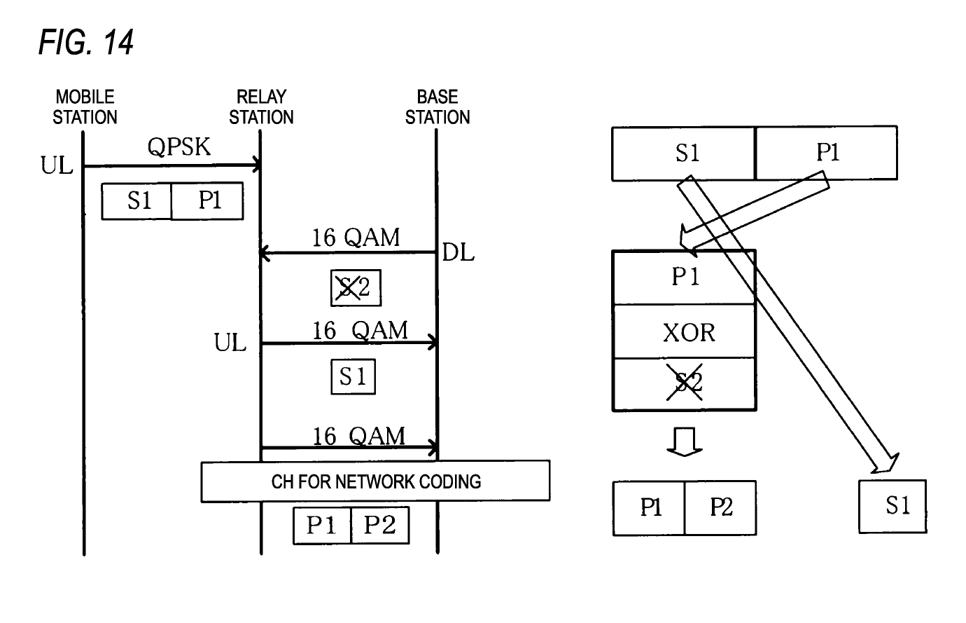

FIG. 14 shows an operation example of the embodiment. Like Embodiment 1, it is assumed that the modulation level from the mobile station to the relay station and from the relay station to the mobile station is QPSK and the modulation level from the base station to the relay station and from the relay station to the base station is 16QAM.

The mobile station transmits a signal S1 and a signal P1 of a parity bit of S1 in QPSK to the relay station and the base station transmits a signal S2 in 16QAM to the relay station. Here, assume that signal S1+P1 relayed to the base station and signal S2 relayed to the mobile station differ in the number of bits and the number of bits of S1+P1 is larger than that of S2.

Of the resource for relay, the resource for network coding is assigned based on S2 and the signal of S1+P1 that cannot be transmitted to the resource for network coding is relayed using the resource for base station from the relay station.

In the example, S1 is more important than P1. If both S1 and S2 can be correctly received, S1 of high importance is assigned to the resource for network coding and P1 is assigned to the resource for the base station from the relay station based on Embodiment 1. The resource for network coding is set to QPSK conforming to S2 and the resource for the base station from the relay station for transmitting P1 is set to 16QAM.

The case where when the relay station receives S2 from the base station, reception of S2 is erroneous and relay of S2 is stopped will be discussed. When relay of S2 is stopped, network coding cannot be performed and relay becomes relay only from the relay station to the base station. Then, the relay station changes the modulation level of the resource for network coding to 16QAM for base station from the relay station.

The possibility that the SNR between the relay station and the base station may be higher than the SNR of the resource for network coding and thus S1 of high importance is preferentially assigned to the resource for the base station from the relay station and P1 of low importance is assigned to the resource for network coding.

At this time, even if P1 is transmitted to the resource for network coding, if there is an empty, further a parity bit P2 is added and is transmitted to the resource for network coding.

[Block Diagram]

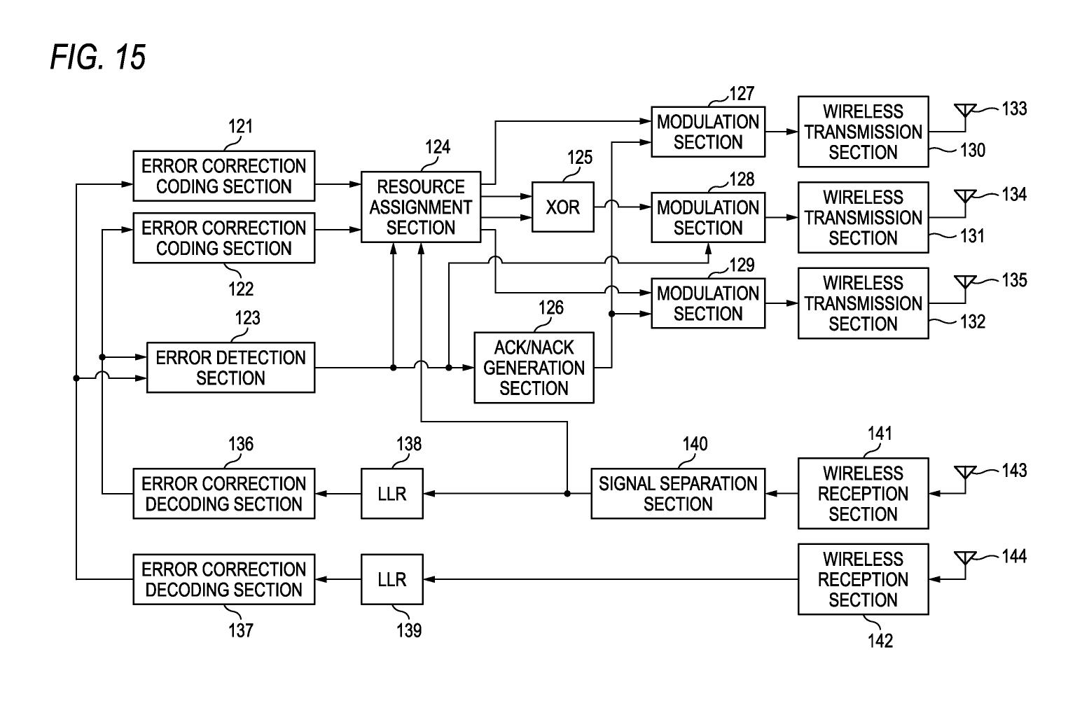

FIG. 15 is a block diagram of the relay station. Portions similar to those in FIG. 8 of Embodiment 2 will not be discussed again. The detection result of an error detection section 123 is input to a resource assignment section 124, an ACK/NACK generation section 126, and a modulation section 128 of the resource for network coding.

If network coding need not be performed from the error detection result, when a signal for the mobile station from the relay station is transmitted, the modulation section 128 of the resource for network coding changes the modulation level of the resource for network coding to the same modulation level as the resource for the mobile station from the relay station and when a signal for the base station from the relay station is transmitted, the modulation section 128 changes the modulation level to the modulation level for the base station from the relay station.

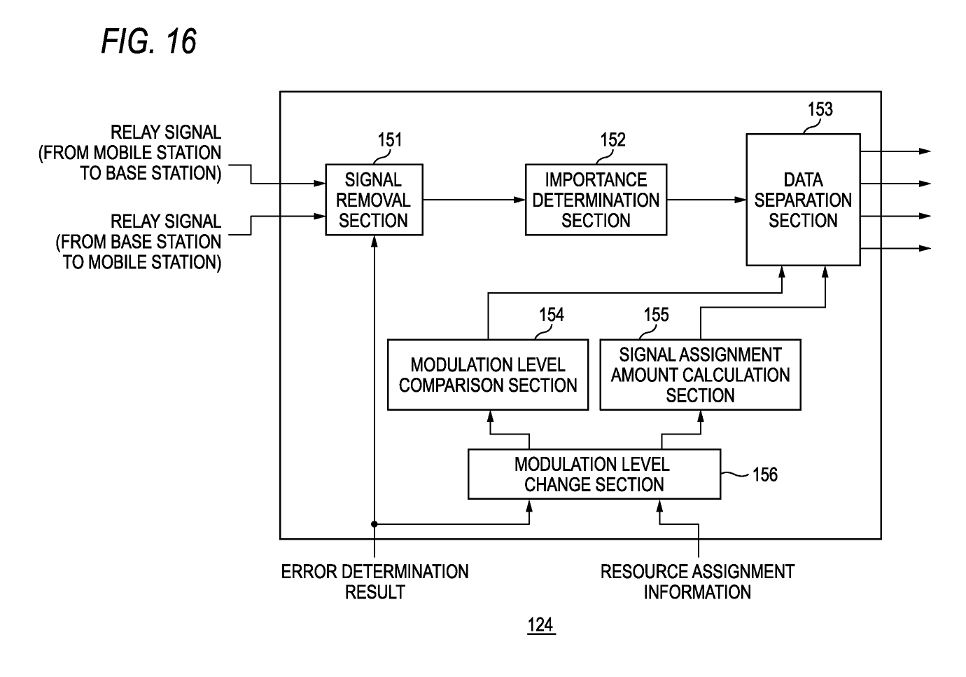

FIG. 16 shows the details of the resource assignment section 124. Parts similar to those in FIG. 12 of Embodiment 3 will not be discussed again. The resource assignment section 124 shown in FIG. 16 includes a signal removal section 151 and a modulation level change section 156 in addition to the resource assignment section 110 in FIG. 12. The error determination result is input to the signal removal section 151 and the modulation level change section 156. Resource assignment information is input to a signal assignment amount calculation section 155 and the modulation level change section 156.

If reception of either a signal from the base station or a signal from the mobile station is erroneous from the error determination result, the modulation level change section 156 changes the modulation level of the resource assignment information for network coding to the modulation level from the relay station to the base station or from the relay station to the mobile station. If no error exists, the resource assignment information is not changed. The resource assignment information output from the modulation level change section 156 is input to a modulation level comparison section 154 and the signal assignment amount calculation section 155.

If the modulation level of the resource for network coding is low as the comparison result for data subjected to importance determination as in FIG. 12, a data separation section 153 performs operation similar to that in Embodiment 1. If the modulation level of the resource for network coding is equal to or greater than that of the resource, the data separation section 153 preferentially assigns a signal of high importance to the resource for the base station from the relay station or the resource for the mobile station from the relay station, outputs the signal to modulation sections 127 and 129, assigns a signal of low importance to the resource for network coding, and outputs the signal to an XOR section 125.

At this time, if one is erroneous and network coding is not performed, the resource for network coding and the resource for the base station from the relay station or the resource for the mobile station from the relay station become the same modulation level and thus the signal of high importance is preferentially output to the resource for the base station from the relay station or the resource for the mobile station from the relay station. If one signal is not input, the XOR section 125 may use a bit string of 0 of dummy bits and may perform XOR.

Thus, in the embodiment, if reception of a signal scheduled for network coding is erroneous, only one line is considered, the modulation level is again set, and the number of relay bits is increased, whereby the error rate characteristic can be improved. Considering occurrence of SNR difference by making the modulation levels uniform, transmission bit is rearranged, whereby the error rate characteristic can be further improved.

[Proper Use]

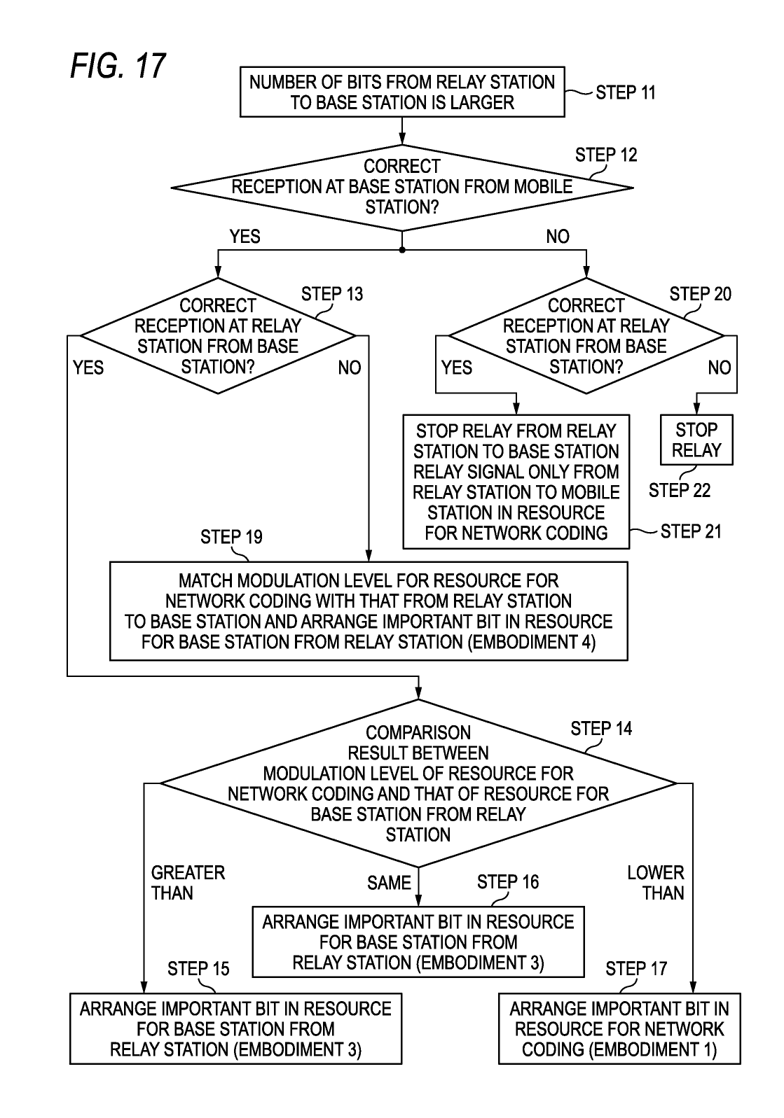

The embodiments described above may be used properly. FIG. 17 is a flowchart of proper use of the embodiments. First, at (Step 11), it is assumed that the number of relay bits from the relay station to the base station is larger than the number of relay bits from the relay station to the mobile station. That is, an operation switch example of the resource assignment section when the number of relay bits from the relay station to the base station is larger is shown below:

If correct reception can be performed at the relay station from the mobile station at (Step 12), the process goes to (Step 13); if correct reception cannot be performed, the process goes to (Step 20). If correct reception can be performed at the relay station from the base station at (Step 13), the process goes to (Step 14); if correct reception cannot be performed, the process goes to (Step 19).

If the modulation level of the resource for network coding is higher than the modulation level of the resource for the base station from the relay station, the process goes to (Step 15); if they are the same, the process goes to (Step 16); and if the former is lower than the latter, the process goes to (Step 17).

When a comparison is made between the modulation level of the resource for the base station from the relay station and the modulation level of the resource for network coding at (Step 15), the modulation level of the resource for the base station from the relay station is lower than the modulation level of the resource for network coding and thus an importance bit is transmitted to the resource for the base station from the relay station.

Since the situation of Embodiment 3 is set at (Step 16), an importance bit is arranged in the resource for the base station from the relay station. Since the situation of Embodiment 1 is set at (Step 17), an importance bit is arranged in the resource for network coding.

If the modulation level of the resource for network coding is higher than the modulation level of the resource for the base station from the relay station, the process goes to (Step 19); if they are the same, the process goes to (Step 20); and if the former is lower than the latter, the process goes to (Step 21).

On the other hand, if correct reception can be performed at the relay station from the mobile station (Step 12: YES) and if correct reception cannot be performed at the relay station from the base station at (Step 13: NO), the operation of Embodiment 4 is performed. That is, an important bit is arranged in the resource for the base station from the relay station. Since network coding need not be performed, the modulation level for the resource for network coding is matched with that from the relay station to the base station. At this time, the number of bits that can be transmitted changes because of the difference between the former modulation level and the post-changed modulation level. Then, if the number of bits that can be transmitted lessens, puncturing is performed for adjustment. If the number of bits that can be transmitted increases, repetition or parity bit is increased for adjusting the number of bits.

If correct reception cannot be performed at the relay station from the mobile station, if correct reception can be performed at the relay station from the mobile station at (Step 20), the process goes to (Step 21); if correct reception cannot be performed, the process goes to (Step 22). At (Step 21), no relay signal exists between the relay station and the base station and thus relay is stopped. At (Step 21), a signal from the relay station to the mobile station is relayed in the resource for network coding. At (Step 22), relay is stopped.

The flowchart 2 of FIG. 17 shows the switching method when the number of bits from the relay station to the base station is large; if the number of bits from the relay station to the mobile station is large, the operation of replacing the relay station and the mobile station is performed.

In the example, the bit of high importance is the systematic bit. However, a control signal, a sound signal, a signal at the first transmission, a bit strict for requirement for a delay, etc., may be preferentially assigned to the resource for network coding as a bit of high importance.

In the block diagram, a plurality of blocks, namely, the wireless reception sections, the LLR, the error correction decoding sections, the error correction coding sections, the modulation sections, and the wireless transmission sections may be shared in transmission and reception to and from the base station, transmission and reception to and from the mobile station, and transmission of network coding.

The signal received at the relay station is relayed at the coding rate as it is by way of example, but a common rule may be provided between the relay station and the mobile station and between the relay station and the base station and the coding rate may be change for relay. The relay method is changed according to the modulation level difference, but may be changed according to the coding ratio difference.

The signal amount subjected to network coding may always be matched with the signal amount from the relay station to the mobile station or from the relay station to the base station. The resource may be a time resource, a resource divided by code, a space resource, or a combination thereof. The relay station in the embodiments described above may be represented as a relay station, a repeater, a simple base station, or a cluster head.

Each of the function blocks used in the description of the embodiments is implemented typically as an LSI of an integrated circuit. The function blocks may be put individually into one chip or may be put into one chip so as to contain some or all. Here, the integrated circuit is an LSI, but may be called an IC, a system LSI, a super LSI, or an ultra LSI depending on the difference in integration degree.

The technique of putting into an integrated circuit is not limited to an LSI and it may be implemented as a dedicated circuit or a general-purpose processor. An FPGA (Field Programmable Gate Array) that can be programmed after LSI is manufactured or a reconfigurable processor wherein connection and setting of circuit cells in LSI can be reconfigured may be used.

Further, if a technology of putting into an integrated circuit replacing LSI appears with the progress of the semiconductor technology or another deriving technology, the function blocks may be integrated using the technology, of course. There can be a possibility of applying a biotechnology, etc.

In the description of the embodiments, antennas are adopted, but the embodiments can also be applied to an antenna port. The antenna port refers to a logical antenna made up of one or more physical antennas. That is, the antenna port does not necessarily refer to one physical antenna and may refer to an array antenna made up of a plurality of antennas or the like. For example, in LTE, how many physical antennas make up an antenna port is not defined and the antenna port is defined as the minimum unit in which the base station can transmit a different Reference signal. The antenna port may be defined as the minimum unit for multiplying weighting of Precoding vector.

While the invention has been described in detail with reference to the specific embodiments, it will be obvious to those skilled in the art that various changes and modifications can be made without departing from the spirit and the scope of the invention.

This application is based on Japanese Patent Application (No. 2008-007970) filed on Jan. 17, 2008, the contents of which are incorporated herein by reference.

### INDUSTRIAL APPLICABILITY

The wireless communication apparatus, the wireless communication method, and the wireless communication system according to the invention are a wireless communication apparatus for relaying communications between the first wireless communication apparatus and the second wireless communication apparatus using the network coding resource and the no-network-coding resource, have the advantage that an important bit is assigned to the network coding resource as a predetermined relay signal and the error rate characteristic can be improved, and are useful as a wireless communication apparatus, a wireless communication method, a wireless communication system, etc.

1. A wireless communication apparatus for relaying communications between a first wireless communication apparatus and a second wireless communication apparatus using a network coding resource and a no-network-coding resource, the wireless communication apparatus comprising:
a resource assignment section that assigns a predetermined relay signal to the network coding resource and a different relay signal other than the predetermined relay signal to the no-network-coding resource.

2. The wireless communication apparatus according to claim 1, wherein the resource assignment section assigns the predetermined relay signal to the network coding resource and the different relay signal to the no-network-coding resource only when a modulation level of the network coding resource is lower than that of the no-network-coding resource.

3. The wireless communication apparatus according to claim 1, comprising:
an error detection section that detects whether or not a received signal has an error and outputs an error determination result to the resource assignment section,
wherein if the error detection section detects a signal error, the resource assignment section preferentially assigns a relay signal to the network coding resource.

4. The wireless communication apparatus according to claim 1, wherein the resource assignment section has a modulation level comparison section for comparing the modulation level of the network coding resource with the modulation level of the no-network-coding resource; and
wherein if the modulation level of the network coding resource is equal to or greater than the modulation level of the no-network-coding resource, the predetermined relay signal is assigned to the no-network-coding resource.

5. The wireless communication apparatus according to claim 1, wherein the resource assignment section has a modulation level change section for changing the modulation level of the network coding resource to the modulation level of the no-network-coding resource if reception of a signal scheduled for relay results in a failure and the signal cannot be relayed.

6. The wireless communication apparatus according to claim 1, wherein the resource assignment section assigns the predetermined relay signal to the network coding resource or the no-network-coding resource in response to the modulation levels set in the network coding resource and the no-network-coding resource and a state of an error of the received signal.

7. A wireless communication method for relaying communications between a first wireless communication apparatus and a second wireless communication apparatus using a network coding resource and a no-network-coding resource, the wireless communication method comprising:
assigning a predetermined relay signal to the network coding resource and a different relay signal other than the predetermined relay signal to the no-network-coding resource.

8. The wireless communication method according to claim 7 comprising:
assigning the predetermined relay signal to the network coding resource and the different relay signal to the no-network-coding resource only when a modulation level of the network coding resource is lower than that of the no-network-coding resource.

9. The wireless communication method according to claim 7, comprising:
detecting whether or not a received signal has an error; and
preferentially using the network coding resource for relay if the error is detected in the received signal.

10. The wireless communication method according to claim 7, comprising:
comparing the modulation level of the network coding resource with the modulation level of the no-network-coding resource; and
assigning the predetermined relay signal to the no-network-coding resource if the modulation level of the network coding resource is equal to or greater than the modulation level of the no-network-coding resource.

11. The wireless communication method according to claim 7, comprising:
changing the modulation level of the network coding resource to the modulation level of the no-network-coding resource if reception of a signal scheduled for relay results in a failure and the signal cannot be relayed.

12. The wireless communication method according to claim 7, comprising:
assigning the predetermined relay signal to the network coding resource or the no-network-coding resource in response to the modulation levels set in the network coding resource and the no-network-coding resource and a state of an error of the received signal.

13. A wireless communication system including a relay station for relaying communications between a first wireless communication apparatus and a second wireless communication apparatus using a network coding resource and a no-network-coding resource, wherein
the relay station includes a resource assignment section for assigning a predetermined relay signal to the network coding resource and a different relay signal other than the predetermined relay signal to the no-network-coding resource.
